(19) United States
(12) Patent Application Publication
(10) Pub. No.: US 2011/0266493 A1
(43) Pub. Date: Nov. 3, 2011

(54) Method of forming encapsulated carbon nanotubes

(76) Inventors: Amjad Ashfaque Shaikh, Solapur (IN); Muataz Ali Atieh, Dhahran (SA); Tahar Laoui, Dhahran (SA)

(21) Appl. No.: 12/662,778

(22) Filed: May 3, 2010

(51) Int. Cl. H01B 1/18; C09K 5/00

(52) U.S. Cl. 252/71; 252/509; 977/742; 977/842; 977/847

(57) ABSTRACT

The method of forming encapsulated carbon nanotubes includes first forming a calcium chloride solution and a sodium hydrogen carbonate solution. A volume of carbon nanotubes are added to the calcium chloride solution and the calcium chloride solution and the volume of carbon nanotubes are then mixed with the sodium hydrogen carbonate solution to form a supersaturated calcium carbonate solution. Carbon nanotubes embedded in calcium carbonate crystals are precipitated from the supersaturated calcium carbonate solution. The carbon nanotubes embedded in the calcium carbonate crystals, forming the precipitate, are then filtered from the solution. The filtered carbon nanotubes embedded in the calcium carbonate crystals are washed and then dried, producing a usable volume of carbon nanotubes encapsulated within calcium carbonate crystals.

### BACKGROUND OF THE INVENTION

1. Field of the Invention

The present invention relates to carbon nanotubes, and particularly to a method of forming encapsulated carbon nanotubes, the carbon nanotubes being embedded in calcium carbonate crystals.

2. Description of the Related Art

Carbon nanotubes (CNTs) are allotropes of carbon with a cylindrical nanostructure. Nanotubes have been constructed with a length-to-diameter ratio of up to 28,000,000:1, which is significantly larger than any other material. These cylindrical carbon molecules have unique properties that make them potentially useful in many applications in nanotechnology, electronics, optics and other fields of materials science, as well as potential uses in architectural fields. They exhibit extraordinary strength and unique electrical properties, and are efficient thermal conductors.

Nanotubes are members of the fullerene structural family, which also includes the spherical buckyballs. The ends of a nanotube might be capped with a hemisphere of the buckyball structure. Their name is derived from their size, since the diameter of a nanotube is on the order of a few nanometers, while they can be up to several millimeters in length. Nanotubes are categorized as single-walled nanotubes (SWNTs) and multi-walled nanotubes (MWNTs).

Techniques have been developed to produce nanotubes in sizeable quantities, including arc discharge, laser ablation, high pressure carbon monoxide (HiPCO), and chemical vapor deposition (CVD). Most of these processes take place in vacuum or with process gases. CVD growth of CNTs can occur in vacuum or at atmospheric pressure. Large quantities of nanotubes can be synthesized by these methods, however the carbon nanotubes produced are typically impure (i.e., they must be separated from other reaction products, usually other forms of carbon) and are only in the form of carbon.

Given the great potential for carbon nanotubes, it would be desirable to provide a method for producing carbon nanotubes in combination with other materials, such as carbon nanotubes embedded within crystalline structures. Since carbon nanotubes cannot easily be applied to materials on their own, the embedding thereof within a carrier or “host” crystal would be particularly desirable. Such a host crystal would preferably be easily dissolvable such that the encapsulated carbon nanotubes could be applied to a desired material, and the outer host crystal would then be dissolved, allowing the carbon nanotubes to be applied or dispersed in a highly controllable manner.

Thus, a method of forming encapsulated carbon nanotubes solving the aforementioned problems is desired.

### SUMMARY OF THE INVENTION

The method of forming encapsulated carbon nanotubes relates to the production of calcium carbonate crystals having carbon nanotubes embedded therein. The method includes first forming a calcium chloride solution and a sodium hydrogen carbonate solution. A volume of carbon nanotubes are added to the calcium chloride solution, and the carbon nanotubes in calcium chloride solution are then mixed with the sodium hydrogen carbonate solution to form a supersaturated calcium carbonate solution.

Carbon nanotubes embedded in calcium carbonate crystals are precipitated from the supersaturated calcium carbonate solution. The carbon nanotubes embedded in the calcium carbonate crystals, forming the precipitate, are then filtered from the solution. The filtered carbon nanotubes embedded in the calcium carbonate crystals are washed and then dried, producing a usable volume of carbon nanotubes encapsulated within calcium carbonate crystals.

These and other features of the present invention will become readily apparent upon further review of the following specification.

### DETAILED DESCRIPTION OF THE PREFERRED EMBODIMENTS

The method of forming encapsulated carbon nanotubes provides for the production of calcium carbonate crystals having carbon nanotubes embedded therein. The method includes first forming a calcium chloride solution and a sodium hydrogen carbonate (sodium bicarbonate) solution. Preferably, approximately 1.014 g of calcium chloride is dissolved in approximately 50 ml of deionized water to form the calcium chloride solution. Similarly, approximately 1.024 g of sodium hydrogen carbonate are preferably dissolved in approximately 50 ml of deionized water to form the sodium hydrogen carbonate solution. Each solution is preferably allowed to mix undisturbed for approximately thirty minutes.

A volume of carbon nanotubes is then added to the calcium chloride solution. The volume of carbon nanotubes is selected so that there is preferably a concentration by volume of less than 1% carbon nanotubes in the solution. Preferably, the carbon nanotubes are allowed to mix undisturbed into the calcium chloride solution for approximately fifteen minutes. The calcium chloride solution with the mixed carbon nanotubes is then added to the sodium hydrogen carbonate solution to form a supersaturated calcium carbonate solution.

Preferably, the calcium chloride solution with the carbon nanotubes is mixed with the sodium hydrogen carbonate solution by combining the two solutions in a beaker or the like and placing the beaker on a magnetic hotplate or the like. Mixing may then be carried out by a magnetic stirrer, as is well known in the art, at a fixed temperature and a fixed mixing rate (for example, at 800 RPM).

The calcium chloride and sodium hydrogen carbonate react in the solution to form the highly supersaturated solution of calcium carbonate. Carbon nanotubes embedded in calcium carbonate crystals are precipitated from the supersaturated calcium carbonate solution. Preferably, precipitation is allowed to occur unhindered for approximately thirty minutes.

Calcium carbonate crystals are ordinarily substantially white in color, but the precipitate is black, due to the presence of carbon nanotubes encapsulated therein. The carbon nanotubes embedded in the calcium carbonate crystals, forming the precipitate, are then filtered from the solution. Any suitable filtration may be used, such as filtration through standard filter paper having a pore size of approximately 0.1 microns. The filtered carbon nanotubes embedded in the calcium carbonate crystals are then washed in acetone or the like, and then dried in an oven, producing a usable volume of carbon nanotubes encapsulated within calcium carbonate crystals. Each individual calcium carbonate crystal is substantially cubical, with a side length of approximately 1 to 1.5 microns, and each encapsulated carbon nanotube has a length of approximately 100 nm.

It is to be understood that the present invention is not limited to the embodiments described above, but encompasses any and all embodiments within the scope of the following claims.

We claim:

1. A method of forming encapsulated carbon nanotubes, comprising the steps of:
(a) forming a calcium chloride solution;
(b) forming a sodium hydrogen carbonate solution;
(c) adding a volume of carbon nanotubes to the calcium chloride solution;
(d) mixing the calcium chloride solution and the volume of carbon nanotubes with the sodium hydrogen carbonate solution to form a supersaturated calcium carbonate solution;
e) precipitating carbon nanotubes embedded in calcium carbonate crystals from the supersaturated calcium carbonate solution; and
f) filtering the carbon nanotubes embedded in the calcium carbonate crystals from the solution.

2. The method of forming encapsulated carbon nanotubes as recited in claim 1, wherein the step of forming the calcium chloride solution includes dissolving a volume of calcium chloride in a first volume of deionized water to form the calcium chloride solution.

3. The method of forming encapsulated carbon nanotubes as recited in claim 2, wherein the step of forming the sodium hydrogen carbonate solution includes dissolving a volume of sodium hydrogen carbonate in a second volume of deionized water to form the sodium hydrogen carbonate solution.

4. The method of forming encapsulated carbon nanotubes as recited in claim 3, wherein the step of dissolving the volume of calcium chloride in the first volume of deionized water to form the calcium chloride solution comprises dissolving approximately 1.014 g of the calcium chloride in approximately 50 ml of the deionized water.

5. The method of forming encapsulated carbon nanotubes as recited in claim 4, wherein the step of dissolving the volume of sodium hydrogen carbonate in the second volume of deionized water to form the sodium hydrogen carbonate solution comprises dissolving approximately 1.024 g of the calcium chloride in approximately 50 ml of the deionized water.

6. The method of forming encapsulated carbon nanotubes as recited in claim 5, wherein the steps of forming the calcium chloride solution and forming the sodium hydrogen carbonate solution each further include allowing the calcium chloride solution and the sodium hydrogen carbonate solution to individually mix for a predetermined period of time.

7. The method of forming encapsulated carbon nanotubes as recited in claim 6, wherein the calcium chloride solution and the sodium hydrogen carbonate solution are allowed to individually mix for approximately thirty minutes.

8. The method of forming encapsulated carbon nanotubes as recited in claim 7, wherein the step of adding the volume of carbon nanotubes to the calcium chloride solution includes adding the volume of carbon nanotubes so that the concentration of carbon nanotubes by volume is less than 1%.

9. The method of forming encapsulated carbon nanotubes as recited in claim 8, wherein the step of adding the volume of carbon nanotubes to the calcium chloride solution includes further includes allowing the calcium chloride solution and the volume of carbon nanotubes to mix for a pre-determined period of time.

10. The method of forming encapsulated carbon nanotubes as recited in claim 9, wherein the calcium chloride solution and the volume of carbon nanotubes are allowed to mix for approximately fifteen minutes.

11. The method of forming encapsulated carbon nanotubes as recited in claim 10, wherein the step of filtering the carbon nanotubes embedded in the calcium carbonate crystals from the solution includes filtration through filter paper.

12. The method of forming encapsulated carbon nanotubes as recited in claim 11, further comprising the step of washing the filtered carbon nanotubes embedded in the calcium carbonate crystals.

13. The method of forming encapsulated carbon nanotubes as recited in claim 12, wherein the filtered carbon nanotubes embedded in the calcium carbonate crystals are washed in a volume of acetone.

14. The method of forming encapsulated carbon nanotubes as recited in claim 13, further comprising the step of drying the filtered carbon nanotubes embedded in the calcium carbonate crystals following the washing thereof.

15. A method of forming encapsulated carbon nanotubes, comprising the steps of:
(a) forming a calcium chloride solution;
(b) forming a sodium hydrogen carbonate solution;
(c) adding a volume of carbon nanotubes to the calcium chloride solution;
(d) mixing the calcium chloride solution and the volume of carbon nanotubes with the sodium hydrogen carbonate solution to form a supersaturated calcium carbonate solution;
(e) precipitating carbon nanotubes embedded in calcium carbonate crystals from the supersaturated calcium carbonate solution;
(f) filtering the carbon nanotubes embedded in the calcium carbonate crystals from the solution;
(g) washing the filtered carbon nanotubes embedded in the calcium carbonate crystals; and
(h) drying the filtered carbon nanotubes embedded in the calcium carbonate crystals.

16. The method of forming encapsulated carbon nanotubes as recited in claim 15, wherein the step of forming the calcium chloride solution includes dissolving a volume of calcium chloride in a first volume of deionized water to form the calcium chloride solution.

17. The method of forming encapsulated carbon nanotubes as recited in claim 16, wherein the step of forming the sodium hydrogen carbonate solution includes dissolving a volume of sodium hydrogen carbonate in a second volume of deionized water to form the sodium hydrogen carbonate solution.

18. The method of forming encapsulated carbon nanotubes as recited in claim 17, wherein the step of dissolving the volume of calcium chloride in the first volume of deionized water to form the calcium chloride solution comprises dissolving approximately 1.014 g of the calcium chloride in approximately 50 ml of the deionized water.

19. The method of forming encapsulated carbon nanotubes as recited in claim 18, wherein the step of dissolving the volume of sodium hydrogen carbonate in the second volume of deionized water to form the sodium hydrogen carbonate solution comprises dissolving approximately 1.024 g of the calcium chloride in approximately 50 ml of the deionized water.

20. The method of forming encapsulated carbon nanotubes as recited in claim 19, wherein the step of adding the volume of carbon nanotubes to the calcium chloride solution includes adding the volume of carbon nanotubes so that the concentration of carbon nanotubes by volume is less than 1%.
